(19) United States
(12) Patent Application Publication
(10) Pub. No.: US 2010/0188587 A1
(43) Pub. Date: Jul. 29, 2010

(54) PROJECTION METHOD

(76) Inventors: Adrian Istvan Ashley, Leicester (GB); David Howells Llewellyn Slocombe, St Albams (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/594,037

(22) PCT Filed: Mar. 31, 2008
(86) PCT No.: PCT/GB08/50233

§ 371 Date: Mar. 22, 2010

(30) Foreign Application Priority Data
Mar. 30, 2007 (GB) 07060305.0

(51) Int. Cl. H04N 9/31

(52) U.S. Cl. 348/744; 348/E09.025

(57) ABSTRACT

There is disclosed a method of displaying a visual image, such as a digital image, on a display surface (10), such as a screen or wall, using a video projector (12). The total area occupied by the complete visual image on the display surface (10) is larger than the area of the projected image (14) produced by the video projector (12). The method comprises determining the location (14a,14b) on the display surface (10) of the projected image produced by the video projector (12). Subsequently, a part of the complete visual image is selected which corresponds in position within the visual image to the location of the projected image (14a,14b) on the display surface (10). The image part is displayed as the projected image (14a,14b). The method has the advantage that all of the projected image (14) can be used to display the visual image, in parts. The video projector (12) can be moved to display any desired region of the complete visual image.

### FIELD OF THE INVENTION

This invention relates to a method of projecting visual information, and in particular to a method of interacting with the projected visual information.

BACKGROUND TO THE INVENTION

It is desirable to make digital visual media more accessible for mobile use through the use of projection technologies, such as laser or LED projectors. The limitation on the use of these projectors is that they are susceptible to the physical motion of the user and require the user to control the projected content by inputting commands with a keypad or touch screen.

U.S. Pat. No. 6,764,185 discloses an interactive display system in which a handheld video projector includes a sensor, which senses the position and orientation of the video projector relative to a display surface. As the video projector is moved, the image projected by the video projector is adapted in order to produce a stable image on the display surface. The image projected by the video projector may include a portion that follows the movement of the projector and can be used as a pointer within the static image.

The system described in the prior art has the disadvantage that, in order to produce a static image, only a small proportion of the usable projection area of the video projector is used, because sufficient unused space must be provided within the projected image to accommodate movement of the video projector relative to the static image.

It would be desirable to project visual information onto a display surface in a manner that uses as much of the available projection area as possible while still being intuitive for the user.

### SUMMARY OF THE INVENTION

Accordingly, this invention provides a method of displaying a visual image on a display surface using a video projector. The total area occupied by the complete visual image on the display surface is larger than the area of the projected image produced by the video projector. The method comprises determining the location on the display surface of the projected image produced by the video projector. The method further comprises selecting a part of the complete visual image. The image part corresponds in position within the visual image to the location of the projected image on the display surface. The method then includes displaying the image part as the projected image.

Thus according to the invention, a visual image that is larger than the area of the projected image produced by a video projector can be displayed by displaying only that part of the visual image that corresponds to the current location of the projected image on the display surface. As the location of the projected image on the display surface changes, the content of the projected image also changes to represent the relevant part of the visual image. This has the advantage over prior art projection methods that the entire available projection area is used to produce an image that is as large and bright as possible.

The location of the projected image on the display surface may be determined in any suitable way. For example, a camera may be used to identify the projected image on the display surface. However, in the presently preferred arrangement, the location of the projected image on the display surface is determined by monitoring the spatial orientation of the video projector. Thus the video projector may be provided with orientation sensors. The orientation sensors may be arranged to sense the rotation of the video projector about one or more axes, for example a vertical axis, and one or more horizontal axes. In a preferred arrangement, the orientation sensors are arranged to sense the rotation of the video projector about three orthogonal axes. One such axis may be collinear with the optical axis of the video projector. The video projector may be initialised in a position with this axis normal to the display surface. Suitable orientation sensors include accelerometers, gyroscopic sensors and tilt switches.

In addition or as an alternative, the location of the projected image on the display surface may be determined by monitoring the spatial position of the video projector. Thus the video projector may be provided with position sensors. The position sensors may be arranged to identify the location and/or movement of the video projector within a suitable coordinate system. Suitable position sensors include accelerometers, global positioning sensors, (laser) rangefinders, gyroscopic or magnetic devices for measuring magnetic north, and the like. The video projector may be initialised in a predetermined position within the coordinate system relative to the display surface.

Accordingly, at least in preferred embodiments, the invention provides a method of navigation, based on the relationship of a projector and its projected visual image on a display surface. Where the projection is able to navigate through a virtual surface of data projecting only the portion of the (dynamically adjusted) data that relates to its new location determined from the sensor's initial position. The location of the projected image on the display surface is implied from the initial position and/or orientation of the projector and subsequent changes in the projector's position and/or orientation.

The display surface may be any suitable shape. For example, the display surface may be flat or curved. The display surface may also be irregular in shape. The display surface may be horizontal, vertical or obliquely orientated with respect to the vertical. In a typical application, the display surface is a wall or horizontal surface such as a desk or table.

Whilst it is feasible for the video projector to be mounted on a stand or gimbals for movement, in the presently preferred arrangement, the video projector is handheld. In this case, position of the projected image on the display surface is changed by the user pointing the video projector at the appropriate location. Laser projectors or LED projectors are preferred because of their relatively small size and weight. Holographic laser projectors have the particular advantage that they do not require focussing.

Where the optical axis of the video projector is at a non-zero angle to the normal to the display surface, distortion (known as keystoning) of the projected image will occur. In a preferred arrangement, the method may further comprise the step of pre-distorting the image part by reference to the location of the projected image on the display surface before the step of displaying the image part as the projected image, whereby the pre-distortion of the image part corrects for distortion of the displayed image part in the projected image due to the relative orientation of the video projector and the display surface. Thus, the pre-distortion may correct for keystoning effects. The pre-distortion may also correct for variations in brightness, colouration, etc. of the projected image.

Where the location of the projected image is determined by means of a camera, any distortion of the projected image may be determined empirically by the camera by detecting the shape of the projected image. In one possible configuration, the projected image may include a machine-identifiable border and pre-distortion may be applied to the image part until the border appears undistorted in the projected image.

The pre-distortion may be applied to the image part in order that the content of the projected image always appears to be facing the user, i.e. the location of the video projector. Alternatively, the pre-distortion may be applied to the image part in order that the content of the projected image always appears to be in the plane of the display surface.

The visual image may be a still image. However, for the best impression on the user, the image should be a moving image. For example, the visual image may be video content. The visual image may be computer-generated content, such as a graphical user interface or a virtual environment for example.

In general, the image, projected image, partial image or selected image relate to image data. In one arrangement, the image data may be read from a memory containing image information for all of the possible positions of the projector (projected image) around the user. The portion of stored data retrieved is then dependent on the processing of the sensor data. The image data may be dynamically created specifically for the current position of the projector (projected image) in relation to the initial position of the projector. The creation of the image data may be based on rules provided by the processing of the position sensor's data. Furthermore, the image data may be dynamically altered data from a video source. In this case, there may be no correction for keystoning.

In a particularly advantageous arrangement, the projected image includes an indicator, such as a pointer or cross hair for example, overlaid on the image part and a user-input device is provided for the user to select a point in the visual image by operating the user-input device when the pointer is located over the desired point. Thus, the video projector may be used as a pointing device. The user input device may be a button, switch or the like, but it could also be a voice activation device or other similar device. Typically a button or switch will be provided on the housing of the video projector as the user-input device. The indicator may be a graphical pointer, but could also be a highlighted part of the image or the content of the image. It is only necessary for the indicator to communicate to the viewer the action that will occur when the input device is actuated. Thus, a selection area may be provided by an area of the projected image, for example the centre. A selectable graphic link may be activated when the link is within this area. Non-pointer based user interface navigation may include menu grid navigation, which is often used on a mobile phone with no pointer. In this case, the indicator is the highlight of the selected portion of the grid.

The position of the indicator relative to the projected image may be substantially constant. Thus, the indicator may be a “fixed” portion of the projected image. Alternatively, the indicator may be arranged to change position within the projected image, for example in the same way that a mouse pointer changes position on a computer screen. Advantageously, the position and/or orientation of the projector may be used to control movement of the indicator within the projected image. For example, a small movement of the projected image in one direction may generate a larger movement of the indicator within the projected image.

This technique can be used to control the position of an indicator within a projected image even where the total displayed image is not larger than the projected image. Thus viewed from a further aspect, the invention provides a method of navigating a digitally-generated indicator region within a visual image projected on a display surface using a digital video projector. The method comprises detecting movement of the video projector and, in response, moving the indicator region relative to the frame of the projected image substantially in the direction of the detected movement.

The invention extends to an image processing device configured to carry out the method of the invention. The device may comprise an input for signals indicative of the location on a display surface of a projected image produced by a video projector. The device may further comprise an image source for a visual image. The image source may be a video feed or a data store, for example. The device may comprise an output connectable to the video projector for outputting an image to be projected. In one arrangement, the image processing device may be provided in the housing of the video processor.

Furthermore, the invention extends to computer software, which when run on a general-purpose computer connected to a video projector and at least one sensor capable of indicating the location on a display surface of a projected image produced by a video projector, configures the general-purpose computer to carry out the method of the invention. The computer software may be run on a personal computer connected to a video projector provided with suitable sensors, for example. Alternatively, the computer software may be run on any computational device having projection capability. The projector and the computer may be in the same physical housing or even on the same circuit board.

### BRIEF DESCRIPTION OF THE DRAWINGS

An embodiment of the invention will now be described by way of example only and with reference to the accompanying drawings, in which:

FIG. 1 is a composite schematic view, partially in plan and partially in elevation, illustrating the principle of operation of the invention;

FIG. 2 is a representation of the distortion of projected images in accordance with the invention;

FIG. 3 is a schematic representation of an embedded computing device according to the invention; and

FIG. 4 is a schematic representation of a mobile projector device utilising an external computing device according to a further embodiment of the invention.

### DETAILED DESCRIPTION OF AN EMBODIMENT

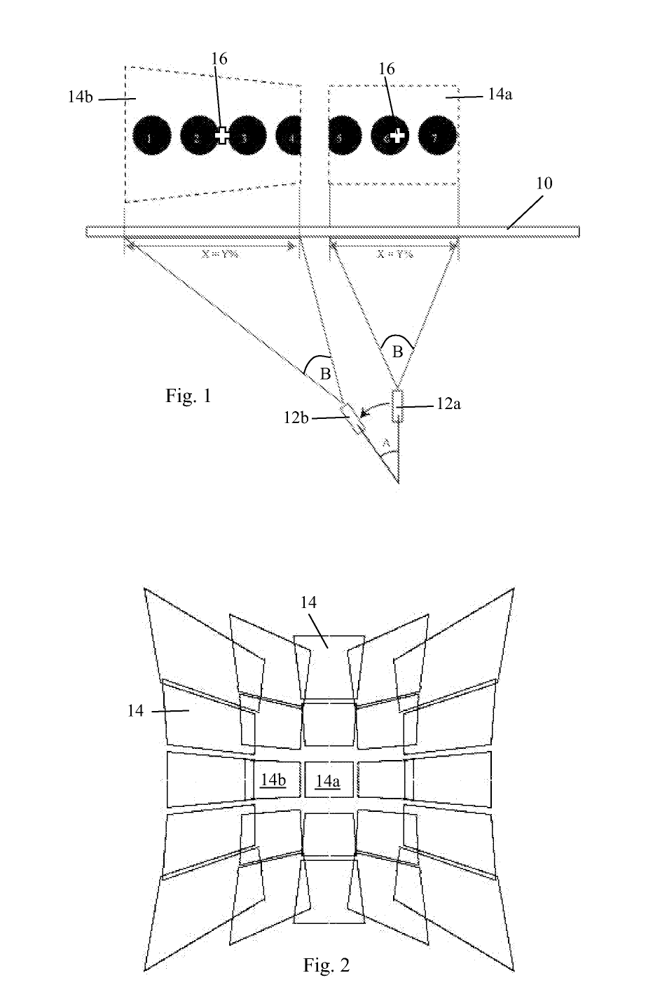

Referring to FIG. 1, the invention provides a method of displaying a visual image, such as a digital image, on a display surface 10, such as a screen or wall, using a video projector 12. The total area occupied by the complete visual image on the display surface 10 is larger than the area of the projected image 14 produced by the video projector 12. The method comprises determining the location 14a, 14b on the display surface 10 of the projected image produced by the video projector 12. Subsequently, a part of the complete visual image is selected which corresponds in position within the visual image to the location of the projected image 14a, 14b on the display surface 10. The image part is displayed as the projected image 14a, 14b.

In FIG. 1, the visual image is a series of numbered circles (1 to 9). The figure shows the video projector 12 in two positions 12a, 12b, with an angle A between the two positions. The video projector 12 and the display screen 10 are shown in plan view, and the resultant projected images 14a and 14b are shown in elevation as they would appear on the display screen 10 to a viewer standing behind the projector. As shown in FIG. 1, with the video projector 12 in the first position 12a, the optical axis of the video projector 12 is normal to the plane of the display surface and the resultant projected image 14a is rectangular. The projected image 14a shows circles numbered 5, 6 and 7 which are in the centre of the visual image. The video projector has a viewing angle B, for example 30 degrees.

When the video projector is moved through an angle A, for example 20 degrees, to the second position 12b, the projected image becomes trapezoidal and increases in length because the optical axis of the video projector 12 is no longer normal to the plane of the display surface 10. This distorting effect is known as “keystoning”, i.e. a square image projected on a wall with the projector aimed straight ahead produces an accurate square image, with all sides parallel, but if the projector is tilted upwards, for example, the square turns into a trapezoid, which is wider at the top than the bottom. Keystoning can be caused on both horizontal and vertical axes of an image. Mobile projectors are susceptible to image stretching and distortion, such as keystoning, when the projector image is projected onto a surface that is not directly in front and parallel to the projector's lens. This reduces the image quality and diminishes the user experience.

With the system described herein, the video projector 12 automatically calibrates (or pre-distorts) the projected image 14b so that when it is projected onto the display surface, the keystoning effect returns the perceived image to its undistorted appearance. Thus, as shown in FIG. 1, even though the video projector 12b has been rotated through 20 degrees and the projected image has been distorted by keystoning, the circles 1, 2, 3, and 4 are undistorted, because the projected image 14b was pre-distorted to compensate for keystoning. In addition, it will be appreciated that in the second position 12b of the video projector 12, the projected image 14b shows those parts (circles 1, 2, 3 and 4) of the visual image that are appropriate to that location in the complete visual image. As the video projector 12 is moved from the first position 12a to the second position 12b, the perceived effect is similar to a torch being scanned across a large picture with regions of the image becoming visible as the torch illuminates them.

As shown in FIG. 2, the projected image can be located at various positions over the display surface 10 in order to display a visual image that is much larger than the area of the projected image 14.

The image part provided to the video projector 12 is calibrated so that the part of the visual image appearing in the projected image 14 always appears to be facing the person holding the projector device 12. For example, this effect enables a user to point the handheld projector around the physical environment they are in and see the projected image with greatly improved legibility. This is achieved by reducing and in some cases removing entirely the stretching of the projected image 14. Stretching of a projected image usually occurs when projected light strikes a surface that is not in front and parallel to the origin of the projector image. This distortion effect is referred to as keystoning, which can be described as an effect of converging verticals and/or horizontals.

This has been the case with traditional fixed location projectors such as office projectors. The distortion of the image coming from a handheld projector is not restricted to only the vertices but is a distortion factor that occurs on both vertical and horizontal sides of a projected image. Furthermore, in some cases, the user will be projecting content for their own viewing so it is beneficial for the usability and legibility of the projected visual image if the content is recalibrated to present itself as a ‘square’ image towards the central location of the projector 12 which is also, in broad terms, the location of the user.

The image part provided to the video projector 12 may alternatively be calibrated so that the projected image 14 appears coplanar with the display surface 10, such as a wall or table. Calibration of the projected image in this manner means the projected image is viewable by many people and is more suited to a presentation situation where not only the viewpoint of the device user must be considered.

Fine tuning software calibration can be performed to adjust the sensor origin coordinates from the location of the projector to the suggested location of the user's eyes. This further calibration adds a higher level of accuracy in terms of legibility to the user. This is managed by utilizing either an automated coordinate model that estimates the average user eye position in relation to the projection or alternatively as a manual adjustment performed by the user that can be stored as a preset coordinate model for current and future use.

Another variation of keystoning is well suited to 3D software environments. The “camera” within the 3D software environment is mapped to the determined position of the video projector 12 using driver software. A data array or algorithm enables the calibration and mapping of the sensor data to the field of view functionality of the 3D environment ‘virtual’ camera, to either increase or decrease the field of view as the projector is moved. For example, if a projector starts in a position pointing directly at a wall, the field of view will be that of the hardware lens on the projector. If the projector is rotated to the right the projected image will be keystoned on the wall, enlarging its surface area. In an application that is a 3D environment such as a Massively Multiplayer Online Role Playing Game (MMORG), the user will pan the environment using the virtual camera as the device and projector is turned to the right, the data and the 3D camera calibration feature is sent to the 3D environment which increases the virtual camera's field of view which, when projected onto the wall, visually compensates for the keystoning. In compensating for keystoning, the use of the ‘virtual camera’ perspective and ‘environment camera’ perspectives of 3D environments is particularly advantageous as it enables a simple means of calibrating for keystoning. Examples are the 3D ‘Aero’ interface in Microsoft Windows Vista or Apple Mac OSX Tiger native 3D or a 3D game play point of view.

The sensor hardware and software system enables automatic or manual calibration of the projected image from a mobile or handheld projector to which the sensor hardware device is attached. The calibration reduces image distortion as viewed from the user's perspective. To achieve this functionality, the software uses hardware sensor data to perform software content calibration such as, but not limited to, position mapping, scaling, rotation and the use of software filters.

A projector's light source is susceptible to alterations in the brightness, contrast and colouration as perceived by the user viewing the projected image 14. An image will appear in its optimal state to a user's perception when the image is squarely projected onto a surface directly in front of the projector. By sensing the coordinate position of the projected image it is possible for the system to calculate the reduction in brightness, contrast and colour that occurs when the projected image is projected onto a non-parallel surface. The system can perform image compensation by adjusting these factors either higher or lower according to the sensed position. These adjustments can be achieved by the system assuming that the user is a) holding the projector and b) initiates the projector when it is pointed squarely at the projection surface.

In addition to displaying the visual image, the system described herein can be used to select information from the visual image. Thus, the centre of the projected image 14 can include a pointer 16, such as an arrow, crosshair, circle or the like (a cross in FIG. 1). The user can move the video projector 12 so that the required part of the visual image is covered by the pointer 16 and press a selection button on the video projector. In this way, the video projector can be used as a navigation device in the manner of a mouse or similar pointing device. The system enables projected content to become easier to navigate for mobile projector users replacing the need for keypad and touch screen input by sensing the position of the projector. Thus, the projector becomes an input device capable of content navigation within the projected content as well as pen-like control and handwriting input.

The hardware and software system provides a unique ability to create an immersive interface experience that can surround the user in up to 360 degrees of content. Content can be in front and behind, above and below and to the sides of the user. It is possible to merge digital content with physical locations. The immersive content environment is able to merge with ‘real’ or ‘physical’ world locations by utilising location-sensing hardware that enables users to associate digital content with physical locations.

The hardware and software system provides a means for projected content to be mapped to achieve total surround content. In the computational model the system can map digital content up to a 360 degree space that is viewable in both planes of rotation and tilt. The user is only able to view a portion of this content at any one time, this portion being limited to the projection angle of the projector. For example, If the projected image is 45 degrees horizontally and 45 degrees vertically then the user will be able to see this portion of any area within a surrounding 360 degree content environment. The portable projector can be pointed around the environment to reveal the content mapped in the 360 degree environment. This 360 degree environment can attain its starting location from the coordinates that are sensed when the sensing hardware system is initialised or recalibrated. Thus, the user may initialise the hardware system with the video projector 12 horizontal and pointing directly at the display surface 10. At this point, the user may also define the size and shape of the available projection area.

The starting coordinates may also come from an identifiable tag which may contain an identity number such as an RFID tag, Datamatrix, bar code or other uniquely identifiable tag. This may also include tags such as an LED light source or other technically sensible tag that is not considered uniquely identifiable.

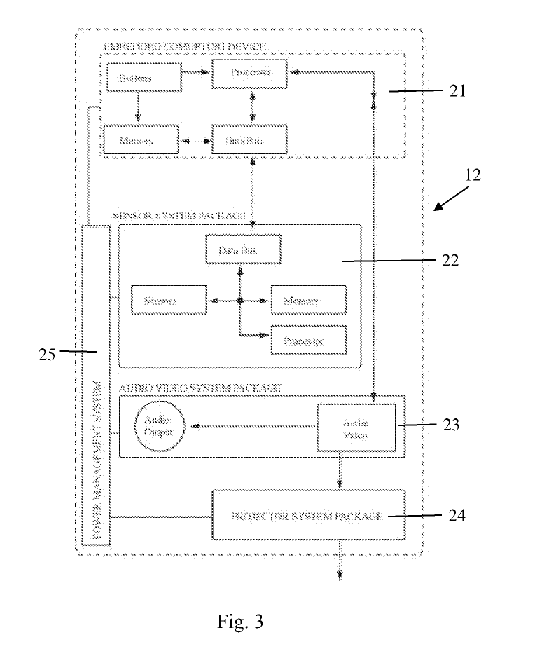

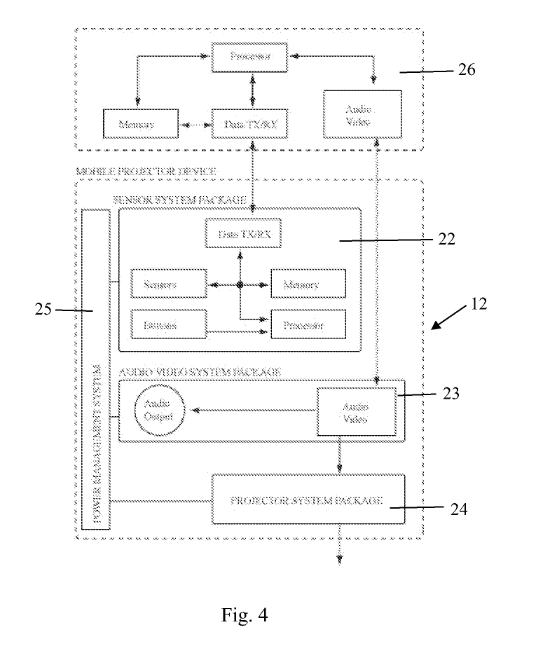

The onboard sensors determine the projector's movements in relation to the projector's position when the sensors were initiated. Using auto keystoning presents the user with up to a possible six planar surfaces forming a virtual cube surrounding the user (and could be called a common real world environment), here the image would appear square on these surfaces. When no keystoning is used it would create a spherical information surface around the projector that would present a non-keystoned projection on a flat surface. FIGS. 3 and 4 show two alternative hardware configurations of a system according to the invention. The system may be embodied in an integral device with a video projector (FIG. 3) or as a video projector and sensor unit for attachment to an external computing device (FIG. 4). Potential product applications are for mobile phones as an embedded or peripheral product enabling mobile phone content input and control. The miniature projector and input and control device combination is also ideally suited for use with personal video players, home or mobile computers and games consoles both mobile and fixed. The device is optimised to run on battery or autonomous power for long periods of time making it particularly suitable for mobile or handheld uses.

As shown in FIG. 3, the video projector device 12 comprises an embedded computing device 21 having buttons, a processor, memory and a data bus in mutual data communication. The device 12 further comprises a sensor system package 22 provided with sensors (described below), a data bus, memory and a processor. The device 12 further comprises an audio and video system package 23 provided with an audio output device, such as a loudspeaker and an audio and video output controller. The device 12 further a projector system package 24, which includes the optical components for video projection, such as lenses and CCD devices. Each of the units, 21, 22, 23 and 24 is supplied with power by a power management system 25.

In the embodiment of FIG. 4, the same components have been given corresponding reference numerals as the components in FIG. 3. However, in this case, the embedded computing device 21 is replaced with an external computing device 26, such as personal computer. However, the operation of both embodiments is generally equivalent.

The projector device 12 device is equipped with position sensors in the sensor package 22 that can detect the position of the projector 12 relative to the position in which the sensors were initialised or re-initialised. This creates a calibration reference for the projection software running on the computing device 21 (or 26) to enable the software to calculate the motion of the content and software environment in relation to a selection area defined by the projected image. For example, when the projector device 12 is tilted upwards, the selection area moves up and the pixels representing the visual image move down correspondingly. In other words, the part of the visual image displayed in the projected image is calculated by reference to the position of the projector device relative to the initial position. This is enabled by the sensor system package 22 sending position data to the embedded computing device 21 by means of internal circuitry or to the external computing device 26 by means of a cable or wireless connection. The computing device uses driver software that manages the software environment control.

The projector device 12 tracks its own position which enables keystoning compensation to make the projected image appear more legible. This functionality requires the software to use the hardware sensor data to perform software content calibration such as, but not limited to, position mapping, scaling, rotation and the use of software filters. This functionality can be resident in a graphics processor or video signal circuitry as an embedded function or as a function of the driver software resident on an external device.

The projection calibration models are acceptable for all ranges of sensing complexity as they are scaleable from the simplest hardware configuration to the most complex within this system. The hardware can consist of a gyroscopic sensor that can detect both X (yaw) and/or Y (pitch) axes. The inclusion of an accelerometer or tilt sensor can provide the Z (roll) axis. A tri-axis gyroscope and tri-axis accelerometer with calibration software can enable highly accurate sensing but may be too costly for most applications.

The sensing hardware can incorporate a compass bearing sensor such as a Hall effect sensor to enable the projected content to be calibrated and modelled around an x axis (yaw) that is true to the earth's magnetic field. The software content can be calibrated to a relationship with the compass data so software elements can be interacted with and moved in relationship to ‘true’ world locations, such as leaving a document at ‘north’ enabling the user to find the content again by pointing the projector at north.

Global positioning hardware can be included in the system to provide a globally accurate location for the modelling of the software environment. The software environment can utilise this data to position the projection calibration models in a relationship to the GPS coordinates providing a computing interface that could effectively merge real world environments with digital environments, made visible by the action of pointing the projector around the real environment.

Interaction with a close surface such as a table for the application of using the handheld projector as a pen input device that is accurate for handwriting input requires the sensing hardware to have the ability to detect linear movement along the x axis. Using a number or combination of the aforementioned sensors it is a feature that can be introduced in the correct context of usage. Alternatives can be camera or laser sensors, similar to those used in computer mice, but able to sense a surface they are close to but not in contact with. This can enable the low cost input of handwriting into a digital writing application.

The hardware system has been designed to be used with laser or light emitting diode (LED), projection technologies as they are small and suitable for handheld, portable applications. Laser technology adds the benefit that the image does not need to be focussed unlike LED light source projectors which require a lens construction to focus the image on a surface.

The hardware and software system supports manual button control from the user. Manual control can be mapped to any control function within the system and to control functions in external software.

The Interactive input and control device is best suited for use with a games console or home computer when it is connected to the external product's video signal. This can be achieved through a standard cable connection but can achieve higher mobility by utilizing an onboard wireless video connection, such as a Wi-Fi or Ultra Wide Band video link.

In summary, this application discloses a method of displaying a visual image, such as a digital image, on a display surface, such as a screen or wall, using a video projector. The total area occupied by the complete visual image on the display surface is larger than the area of the projected image produced by the video projector. The method comprises determining the location on the display surface of the projected image produced by the video projector. Subsequently, a part of the complete visual image is selected which corresponds in position within the visual image to the location of the projected image on the display surface. The image part is displayed as the projected image. The method has the advantage that all of the projected image can be used to display the visual image, in parts. The video projector can be moved to display any desired region of the complete visual image.

In a variation of the described system, the projected image is like a standard video projector, but the mouse movement is based on the position data of the projector. The projected image may be substantially the same size as the source image. The displayed image can be keystoned within the edge of the projection boundary. The user can interact with content using a pointer in the middle of a 60 cm by 60 cm projected image with the projector is pointing directly at the wall. When the user rotates their hand holding the projector, the projected content follows this movement, but the pointer moves over the top of the content at a faster rate than the rate of movement of the projector. In this way, the position of the pointer within the projected image can be changed. Thus, the user need only move the projected image a few centimetres and the mouse pointer will be at the edge of the screen. Both the navigation or the change in projected image can be paused or stopped to allow correction or to produce dragging effects. This interface may use a mouse or it may use menu to menu selection, such as a cell phone where there is no mouse but a list or grid of icons.

In one arrangement, a pc outputs a screen size of 1600×1200 pixels which is connected to the input port of a projector. Inside the projector the image port is connected to an image processor which can manage the resolution 1600×1200. There is another function whereby the input image from the port is manipulated by a microprocessor to perform any orientation correction. A mouse function is implemented and the mouse location data is sent back to the pc. The pc is just outputting a standard video output with no motion calibration, and the projector calculates the necessary mouse location on the pc screen based on the projector's measurements of its own movements since the projector was initiated. What the user will see if the pc screen is on is the pc mouse moving around, what they will see on the projector is a keystoned and re-orientated image that they can interact with by point and click. This means there is no need for software on the pc other than standard head-up display (HUD) human interface device drivers. The central portion of the 1600×1200 image, for example an area that is 800×800 pixels, is output to the internal microdisplay of the projector. The light from the internal light source is bounced off this screen and the projected image is visible and interactive.

1. A method of displaying a visual image on a display surface using a video projector, wherein the total area occupied by the complete visual image on the display surface is larger than the area of the projected image produced by the video projector, the method comprising:
determining the location on the display surface of the projected image produced by the video projector;
selecting a part of the complete visual image, the image part corresponding in position within the visual image to the location of the projected image on the display surface; and
displaying the image part as the projected image.

2. A method as claimed in claim 1, wherein the location of the projected image on the display surface is determined by monitoring the spatial orientation of the video projector.

3. A method as claimed in claim 1, wherein the location of the projected image on the display surface is determined by monitoring the spatial position of the video projector.

4. A method as claimed in claim 1, wherein the video projector is handheld.

5. A method as claimed in claim 1 further comprising the step of pre-distorting the image part by reference to the location of the projected image on the display surface before the step of displaying the image part as the projected image, whereby the pre-distortion of the image part corrects for distortion of the displayed image part in the projected image due to the relative orientation of the video projector and the display surface.

6. A method as claimed in claim 1, wherein the projected image includes an indicator overlaid on the image part and a user-input device is provided for the user to select a point in the visual image by operating the user-input device when the indicator is located over the desired point.

7. A method as claimed in claim 6, further comprising detecting movement of the video projector and, in response, moving the indicator region relative to frame of the projected image substantially in the direction of the detected movement.

8. A method of navigating a digitally-generated indicator region within a visual image projected on a display surface using a digital video projector, the method comprising detecting movement of the video projector and, in response, moving the indicator region relative to the frame of the projected image substantially in the direction of the detected movement.

9. A method as claimed in claim 1, wherein the visual image is a moving image.

10. An image processing device configured to carry out the method of claim 1, the device comprising:
an input for signals indicative of the location on a display surface of a projected image produced by a video projector;
an image source for a visual image; and
an output connectable to the video projector for outputting an image to be projected.

11. Computer software, which when run on a general-purpose computer connected to a video projector and at least one sensor capable of indicating the location on a display surface of a projected image produced by a video projector, configures the general purpose computer to carry out the method of claim 1.

12. (canceled)

13. (canceled)
